(19) United States
(12) Patent Application Publication
(10) Pub. No.: US 2011/0044883 A1
(43) Pub. Date: Feb. 24, 2011

(54) METHOD OF PURIFYING GYPSUM

(75) Inventor: Perttu Heiska, Espoo (FI)

Correspondence Address: YOUNG & THOMPSON, 209 Madison Street, Suite 500, Alexandria, VA, 22314, US

(73) Assignee: KEMIRA OYJ, Helsinki (FI)

(21) Appl. No.: 12/936,918

(22) PCT Filed: Apr. 8, 2009
(86) PCT No.: PCT/FI09/50263

§ 371 Date: Nov. 10, 2010

(30) Foreign Application Priority Data
Apr. 9, 2008 (FI) 20085296

(51) Int. Cl. C01F 11/46

(52) U.S. Cl. 423/555

(57) ABSTRACT

A method of purifying flue gas desulfurization (FGD) gypsum. The method includes the steps of a) providing an aqueous slurry containing said FGD gypsum, b) passing the aqueous slurry to a magnetic separator, and c) contacting the FGD gypsum to be purified with a solution containing an acid and having pH below 5 in an acid washing step. Also, a purified FGD gypsum obtained by the inventive method and the use thereof as coating or filler pigment for paper or board.

### FIELD OF THE INVENTION

The present invention relates to utilization of the waste obtained when removing sulfur dioxide from flue gases. When calcium scrubbing components are used to capture the sulfur dioxide, calcium sulfate is formed. The present invention discloses a method of purifying such flue gas desulfurization (FGD) gypsum so that it is acceptable for utilization.

### BACKGROUND OF THE INVENTION

Flue gas desulfurization (FGD) gypsum is formed during the removal of sulfur dioxide from flue gases when using calcium scrubbing components such as limestone or lime to capture the sulfur dioxide. Flue gases are produced for example in electric power plants where a carbonaceous material is combusted. Such flue gases containing sulfur dioxide also contain other impurities such as fly ash, carbon and oils. Although the flue gas is typically purified using several techniques, some of the organic and inorganic impurities pass to the flue gas desulfurization unit and subsequently to the waste discharged from the flue gas desulfurization unit. Therefore the FGD gypsum obtained may contain high amount of impurities.

In Europe about 8 million tons and in the USA about 26 million tons of FGD gypsum is produced annually. Major part of this FGD gypsum is utilized in construction industry. But still a significant part of it is stored at the factory sites, dumped to landfills or pumped as a slurry to seas.

Typically side product gypsums contain varying amounts of impurities, which are originated from the raw material used in the process. These impurities complicate the utilization of the gypsum and restrict the placing of thereof for example to the environment. The orders of the authorities have set limits to the amounts of impurities that the gypsum may contain before it is for example dumped to a sea. Therefore different purification methods have been developed, especially to remove metallic compounds from the gypsum.

The use of magnetic separation in the purification of gypsum is described in F1101787 B1, which disclosed a process for purifying gypsum of heavy metal impurities and impurities of the lanthanide group by means of a strong-magnetic separation. This process is used for the purification of gypsum produced as a side product of another process such as phosphogypsum or FGD gypsum.

A method of purifying flue gas desulfurization aqueous waste slurry is disclosed in U.S. Pat. No. 6,197,200. Said method comprises supplying the aqueous waste slurry to a screening station to remove the grits, passing the grit-free aqueous waste slurry to a magnetic separator to remove fly ash components, and transferring the aqueous slurry to a floatation cell to remove carbon and oils therefrom. The purified aqueous slurry of calcium-sulfur salts is used i.a. in producing alpha-hemihydrate gypsum.

The use of magnetic separation devices for removing magnetic particles from a slurry is well known. One method is High Gradient Magnetic Separation (HGMS) such as disclosed in U.S. Pat. No. 3,676,337, wherein particles are attracted to and trapped in a magnetized filter element containing a matrix such as steel wool based on high magnetic field gradients created by the magnetized matrix. At some point the capacity of the matrix is reached and it is necessary to turn off the magnetic field and flush the particles out with a flowing liquid. A variant on the Kolm HGMS is described in U.S. Pat. No. 3,902,994, which discloses a plurality of matrix containing elements on a carousel, so that one or more elements can be cleaned while another is in service.

The use of strong-magnetic separation is also disclosed by Iannicelli, J. in “New developments in magnetic separation”, Magnetics, IEEE Transactions, Vol. 12, (September 1976), pp. 436-443, where the evolution of high extraction magnetic filters used commercially by all major kaolin producers is reviewed. Especially the separation of iron and titan impurities from kaolin is disclosed.

A continuous magnetic separator and process for separating a slurry comprising magnetic particles into a clarified stream and a thickened stream is disclosed in WO 2003/064052. A continuous magnetic separator is specifically distinguished from a batch separator where one component, generally the magnetic solid, is retained in the separator and periodically removed. The continuous separator is also distinguished from a sequence or carrousel of batch reactors that are sequenced to simulate steady flow.

As mentioned the unpurified FGD gypsum contain unacceptable high amount of impurities for it to be utilized or even located in the environment. The problem with the above purification methods is that they remove the impurities only partially and therefore the gypsum obtained is not optimal to be used for example as coating or filler pigment for paper or board. Pigments suitable for the coating of paper and for other uses involve the problem of a low degree of brightness. In many uses, brightness higher than at present would be desirable. For example, modern printed products are required to have as high brightness as possible.

A process for the bleaching of pigments using peracetic acid (PAA) is described in U.S. Pat. No. 6,270,564. The use of PAA improves the brightness also with pigments which do not contain any organic oxidizable components. In this bleaching process the peracetic acid is dosed into an aqueous slurry of the pigment, the slurry being stirred simultaneously. The dry matter content of the slurry is about 30 to 80 wt-%. The peracetic acid addition lowers the pH value of the slurry to be bleached, but it is said that in general it is not necessary to control the acidity of the slurry. In the Examples disclosed in U.S. Pat. No. 6,270,564, good bleaching results were obtained when the pH value ranged from 2 to 12. U.S. Pat. No. 6,270,564 does not teach the mechanism how the peracetic acid works in the process nor what components influencing the brightness are actually removed or reacted during the process. It only discloses the results obtained.

None of the state-of-the-art processes is capable of purifying FGD gypsum sufficiently. Thus there is a clear need in the art for a purifying process by which the brightness and whiteness of FGD gypsum could be increased and yellowness decreased.

### BRIEF DESCRIPTION OF THE INVENTION

An object of the present invention is thus to provide a method of purifying flue gas desulfurization (FGD) gypsum so as to alleviate the above disadvantages. The objects of the invention are achieved by the method which is characterized by what is stated in the claim 1. The other objects of the invention are disclosed in the subsequent independent claims. The preferred embodiments of the invention are disclosed in the dependent claims.

The invention is based on the realization that FGD gypsum is an inexpensive source for substituting natural gypsum and that with effective purification FGD gypsum can be utilized in similar applications as natural gypsum. The inventors have surprisingly found out that the brightness and whiteness of FGD gypsum can be significantly increased and yellowness decreased by a purification process that comprises a magnetic separation step as well as an acid wash step.

The present invention provides a method of purifying flue gas desulfurization (FGD) gypsum, wherein an aqueous slurry containing said FGD gypsum is provided, and said aqueous slurry is passed to a magnetic separator. During the purification the FGD gypsum is also contacted with a solution containing an acid and having pH below 5 in an acid washing step.

The method of the invention enables the use of low cost raw material, FGD gypsum, in the production of high quality products. It also provides an alternative for the diminishing natural resource i.e. natural gypsum. The utilization of the invention is also environmentally beneficial, because the FGD gypsum used as the raw material in the present invention could otherwise be dumped to the nature.

### BRIEF DESCRIPTION OF THE DRAWINGS

In the following the invention will be described in greater detail by means of preferred embodiments with reference to the accompanying drawings, in which

FIG. 1 illustrates a block diagram of an embodiment of the invention, wherein the magnetic separation is done before the acid wash step;

FIG. 2 illustrates a block diagram of another embodiment of the invention, wherein the magnetic separation is done after the acid wash step; and

FIG. 3 illustrates a block diagram of a further embodiment of the invention, wherein the method comprises additional steps.

### SUMMARY OF THE INVENTION

Gypsum is a mineral composed of calcium sulfate dihydrate, with the chemical formula CaSO₄.2H₂O. Calcium sulfate has several different crystal forms. Heating gypsum to between 100° C. and 150° C. partially dehydrates the mineral by driving off approximately 75% of the water contained in its chemical structure. The reaction for the partial dehydration is:

CaSO₄.2H₂O+heat→CaSO₄.½H₂O+1½H₂O(steam)

The partially dehydrated mineral is called calcium sulfate hemihydrate or calcined gypsum (commonly known as plaster of Paris), CaSO₄.nH₂O, where n is in the range 0.5 to 0.8. The dehydration, specifically known as calcination begins at approximately 80° C., although in dry air, some dehydration will take place already at 50° C. The conditions of dehydration can be changed to adjust the porosity of the hemihydrate, resulting in the so-called alpha and beta hemihydrates, which are more or less chemically identical.

On heating to 180° C., the nearly water-free form, called γ-anhydrite (CaSO₄.nH₂O, where n=0 to 0.05) is produced. γ-Anhydrite reacts slowly with water to return to the dihydrate state. On heating above 250° C., the completely anhydrous form called β-anhydrite or “natural” anhydrite is formed.

In the present invention by “gypsum” is meant the dihydrate form of calcium sulfate.

The present invention relates to a method of purifying flue gas desulfurization (FGD) gypsum, the method being characterized by comprising the following steps:
a) providing an aqueous slurry containing said FGD gypsum,
b) passing said aqueous slurry to a magnetic separator, and
c) contacting the FGD gypsum to be purified with a solution containing an acid and having pH below 5 in an acid washing step.

The unpurified FGD gypsum is fed to the magnetic separator as aqueous slurry, wherein the amount of solids may vary. The solids content of the aqueous slurry is typically above 1 wt-%, preferably above 10 wt-%, and more preferably above 20 wt-% based on the total mass of the slurry. The solids content of the slurry fed to the separator should be low enough for the slurry to flow, typically lower than 90 wt-%, preferably lower than 80 wt-%, and more preferably lower than 70 wt-%. In one embodiment of the invention the aqueous slurry containing the FGD gypsum formed in step a) has a solids content from 20 wt-% to 80 wt-% based on the total mass of the slurry. For better magnetic separation the solids content should be as low as possible, but for the productivity it is preferable to use higher concentrations. Also the amount acid used in the acid wash step would be high if the amount of water is increased.

The particles may range in size from nominally a millimeter down to sub-micrometers. Most preferably they range in size from one micrometer up to a few hundred micrometers, such as from 1 μm to 500 μm. The upper limit on the particle size is determined by requirements for a stable flowable slurry.

If the slurry contains particles having too large particle size then the process may comprise screening of the aqueous slurry. Screening is preferably done before magnetic separation, but in an embodiment of the invention the screening is done in the magnetic separator, wherein the magnetic mesh or matrix works as a screening unit. The big particles hinder the magnetic separation or the magnetic separation is not as effective as if the particle size would be smaller. If the slurry contains big particles then the matrix of the magnetic separator should also have big mesh size, which lowers the separation efficiency. On the other hand if a small mesh size matrix is used then it would be clogged more easily. Thus, from the separation efficiency point of view it is more preferable to have the screening before the magnetic separation.

In an embodiment of the invention the magnetic separator used in step b) is a high gradient magnetic separation (HGMS) unit. In such a unit the aqueous slurry flows through the separator and impurities attach to the matrix, wherein magnetic flux takes an effect on the magnetic particles. The magnetic separator is operated with a magnetic flux density from 0.1 to 5 Tesla, preferably above 0.5 Tesla, and more preferably from 1.0 to 2.5 Tesla. Also other types of magnetic separation units may be used, such as superconductive magnets.

The impurities attached to the matrix can be removed by removing the magnetic flux. This can be done either by switching off the electricity from the unit or by removing the matrix from the magnetic field. In the first one is typically a batch separator where the magnetic solids are retained in the separator and periodically removed and the second one is typically sequence or carrousel of batch reactors that are sequenced to simulate steady flow. It is also possible to utilize a continuous magnetic separator, wherein the slurry comprising magnetic particles is separated into a purified stream and a stream containing the magnetic particles as disclosed in WO 2003/064052.

The metallic impurities contained in the aqueous slurry that are removed during magnetic separation may include in addition to iron and titan compounds also heavy metals and elements from the lanthanide group. Metallic impurities that may be removed contain metals such as Cu, Ni, Zn, Pb, Cr, Co, As, Fe, Al, Mg, Ti and Y and elements from the lanthanide group such as La, Ce, Pr, Nd, Pm, Sm, Eu, Gd, Tb, Dy, Ho, Er, Tm, Yb and Lu.

The purification method of the present invention also comprises contacting the FGD gypsum to be purified with a solution containing an acid and having pH below 5 in an acid washing step. In this step i.a. organic impurities contained in the FGD gypsum may be removed. The acid used may be a mineral acid such as hydrochloric acid, nitric acid, phosphoric acid, sulfuric acid, boric acid, and hydrofluoric acid, or water soluble organic acid such as acetic acid, peracetic acid, formic acid, citric acid and oxalic acid, a preferred acid is sulfuric acid. The acid should be used in amount sufficient to lower the pH of the acid containing solution is below 5, preferably below 4 and more preferably below 3. In one embodiment the pH of the solution is adjusted to a level from 1.5 to 3.0.

The temperature during the acid wash step is typically room temperature i.e. about 18 to 25° C. However, the acid wash step may be done also in colder temperature such as at 10° C. with good results. In order to facilitate the purification, temperature may be raised above 40° C., preferably to a temperature between 40° C. and 60° C.

In an embodiment the acid wash step c) is done in a mixing vessel. The residence time of the FGD gypsum in said mixing vessel is typically more than 1 minute, preferably more than 10 minutes, and more preferably more than 30 minutes. The residence time may be for example from 0.5 hours to 2.0 hours, depending on the amount of impurities and purification level wanted. In another embodiment of the invention, the acid wash step is carried out in a tube line, wherein the length of the tube line and the flow rate determines the “residence time”. The mixing can also be carried out in any other way known to person skilled in the art, such as with a rotor stator mixer. With such a efficient mixer as rotor stator mixer the residence time of the FGD gypsum in said mixing stage may be significantly decreased. Then residence times even below 1 minute are possible.

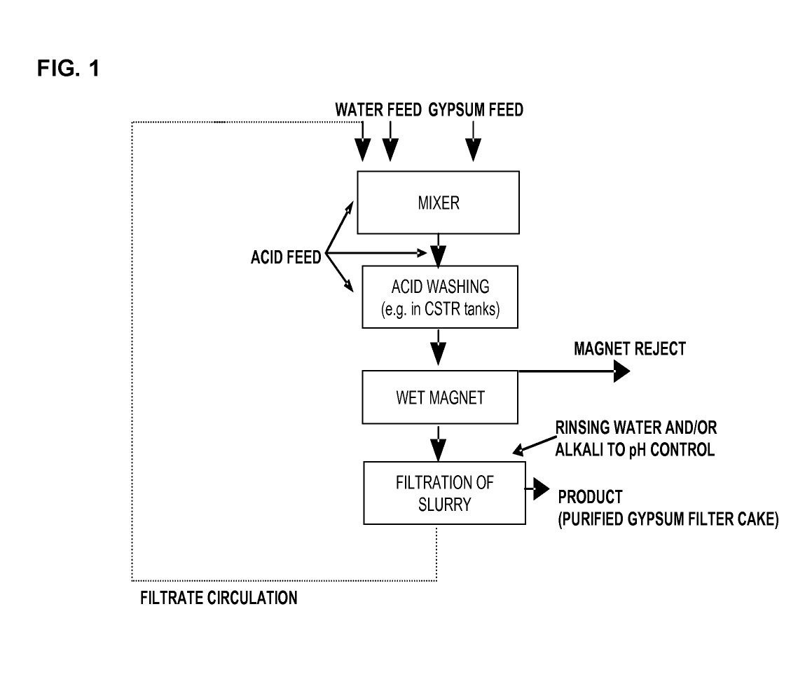

In an embodiment of the invention illustrated in FIG. 1 the FGD gypsum and water is fed to a mixer to provide the aqueous slurry containing said FGD gypsum, the aqueous slurry is then passed to a magnetic separator and magnetic components contained in said aqueous slurry are removed (as magnet reject). In order to improve the effect of the magnetic separator it is possible to circulate at least a part of the aqueous slurry that has passed through magnetic separator back to the feed stream of the magnetic separator In another embodiment it is possible to have two more magnetic separators in cascade. After removal of the magnetic components the aqueous slurry is transferred for the acid washing step to a vessel, wherein also the acid is fed. The acid can be fed either directly to the vessel or in the connection line between the magnetic separator and the acid wash vessel. The slurry is kept in the vessel under the acidic conditions for a period of time whereafter the purified FGD gypsum is separated from the slurry, for example by filtration. The separated gypsum is rinsed with water and finally the rinsed product is recovered as purified FGD gypsum. If the further processing of the gypsum requires neutralization of the gypsum, the rinsing water may also contain an alkali to control the pH of the product. The alkali used may be any suitable alkali used in the chemical industry such as calcium hydroxide, sodium hydroxide, potassium hydroxide, or ammonia, preferably it is calcium hydroxide. Typically when alkali is used it is added to the rinsing water in an amount, which is adequate raise the pH of the product to at least 5, preferably to a pH from 6 to 8.

The gypsum may be separated from the water by several different techniques. As mentioned above filtration may used for water separation. Typical filters in clued vacuum belt filters, especially horizontal vacuum belt filters such as rubber belt filter (RBF) and reciprocating tray-type belt filter (RTBF). A rotary drum vacuum filter is also one of the alternatives for gypsum dewatering.

FGD gypsum slurry suspension is easy to dewater by using both filtration and sedimentation centrifugation techniques. The feed material offered to centrifuges contains a small amount of very fine fly ash. A decanter centrifuge is not equipped to remove this small fraction of impurity. In FGD filtration type centrifuges it is possible to remove the fine fly ash particles. FGD centrifuges are vertical basket centrifuges equipped with the gutter arrangement.

Also other filtration may be utilized, such as steam pressure filtration. Steam pressure filtration is based on differential pressure filtration, but it uses steam instead of pressurized air. The steam penetrates the filter cake and heats up the moist product to condensation temperature, creating an even displacement front. The filter cake dries also due to heat stored in the hot cake.

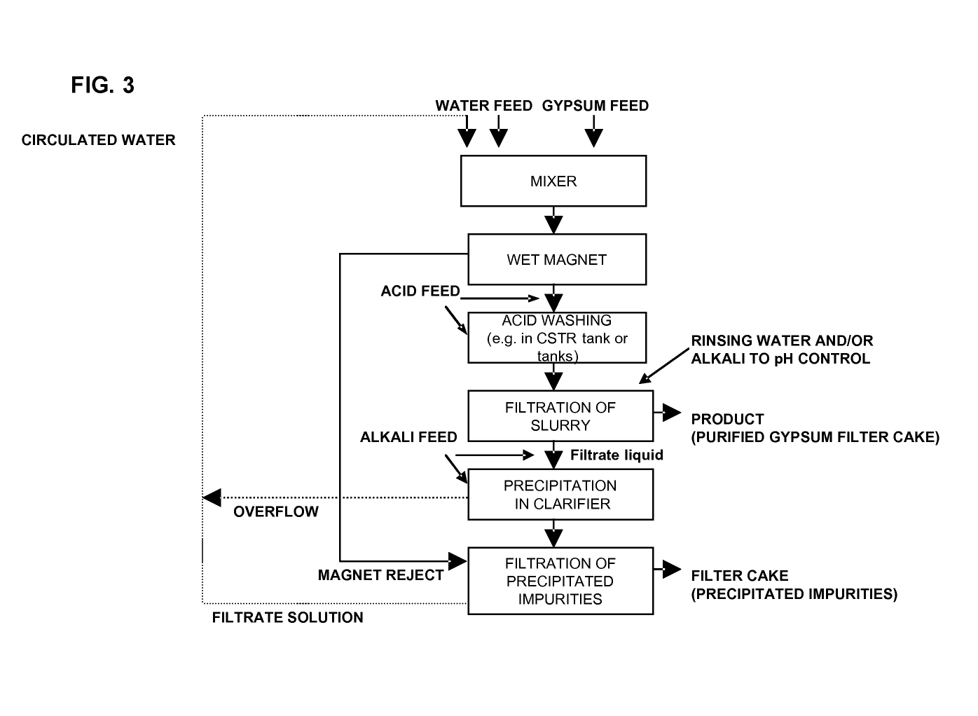

Water circulation should be maximized in all factories in order to minimize the amount of waste water produced. Therefore in a preferred embodiment of the method of the present invention the waste water from slurry and rinsing water may be at least partially circulated back to first stage where water and unpurified FGD gypsum are mixed. In an embodiment this is done by collecting the water from the slurry and the rinsing water into a clarifier after the purified FGD gypsum is separated therefrom and the overflow water from the clarifier is circulated back to first stage where water and unpurified FGD gypsum are mixed and the sediment containing precipitated impurities is rejected (FIG. 3).

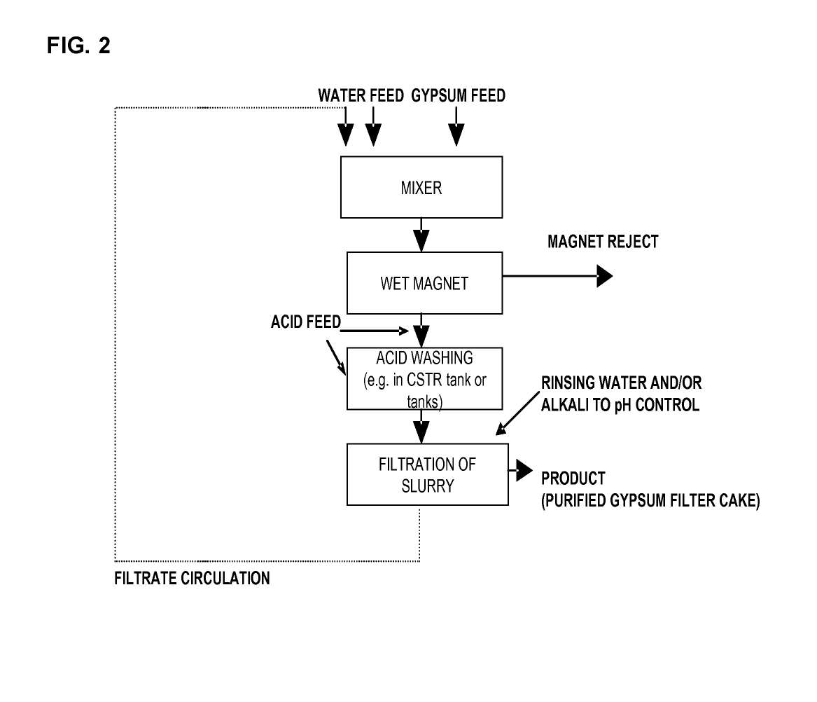

The purification steps of the method may be in any order. Typically the magnetic separation is before the acid wash step (FIG. 1), but it is also possible that the acid washing step is prior to the magnetic separation (FIG. 2). In the latter case the acid may be added to the mixer together with the FGD gypsum and water in order top form an acidic FGD gypsum slurry. In this case the mixing vessel and the acid wash vessel are the same. As shown in FIG. 2, it is also possible that the mixer for the unpurified FGD gypsum and water in done a separate vessel and the acid wash step is done in another vessel such as a continuous stirred tank reactor (CSTR). Because acidic slurry may provoke corrosive attack of the magnetic separation unit, it may be beneficial to have the magnetic separation before the acid wash step.

FIG. 3 shows a more complex block diagram of inventive method. This method comprises a few additional steps. In this method the FGD gypsum and water is fed to a mixer to provide the aqueous slurry containing said FGD gypsum. The aqueous slurry is then passed to a magnetic separator and magnetic components contained in said aqueous slurry are removed as magnet reject and transferred to a filtration unit, wherein the impurities and filtrate solution are separated. After removal of the magnetic components the aqueous slurry is transferred for the acid washing step to a vessel such as CSTR, wherein also the acid is fed. The acid can be fed either directly to the vessel or in the connection line between the magnetic separator and the acid wash vessel. The slurry is kept in the vessel under the acidic conditions for a period of time whereafter the purified FGD gypsum fed to a filtration unit, wherein the FGD gypsum is separated from the slurry. The filtrated gypsum is rinsed with water or with an alkaline solution. Finally the rinsed product is recovered as purified FGD gypsum filter cake. The filtrate liquid is collected into a clarifier and solids contained in the liquid are allowed to precipitate and settle to the bottom of the clarifier. The overflow water from the clarifier is circulated back to first stage where water and unpurified FGD gypsum are mixed and the sediment containing precipitated impurities are transferred to the same filtration unit were the magnetic reject is also collected. From this filtration unit the precipitated impurities are removed as a filter cake and the filtrate solution is circulated at least partially to the mixer.

The present invention also relates to purified FGD gypsum obtained by the inventive method. Especially the present invention relates to the use of the purified FGD gypsum as coating or filler pigment for paper or board, or as building material. In these applications the color of the product is important. The features that are especially important in the paper applications are brightness, whiteness and yellowness. Construction applications for gypsum include wallboard, plaster, flooring, aerated blocks, road base and well drilling. Other possible uses for pure high quality gypsum include: industrial plasters, such as ceramics and pottery, decorative finishes, adhesives and grouts; high purity application, such as medical/surgical, dental, food, beer, bread, pharmaceutical and agrochemicals; or other miscellaneous uses, such as animal feeds, pigments, plastics, rubber, soil conditioning and water treatment. Thus, pure gypsum can be used for example as bread improver, dental plaster, surgical plaster or pharmaceutical carrier.

The invention will now be illustrated with the aid of some non-limiting examples.

### EXAMPLES

### Example 1

### Experimental Set-Up for Acid Wash Experiments

About 70 g of gypsum was weighted into a beaker. The beaker was made up to 200 cm³ with distilled water and pH value was adjusted to the desired value by adding sulfuric acid. Then the possible additives were added. The obtained suspension was heated to the desired temperature and temperature was maintained during the reaction. The reaction was determined to begin when the desired temperature was reached. After stirring the sample was filtered and washed with lukewarm distilled water. The sample was moved to an evaporation basin and was allowed to dry at ambient temperature.

The magnetic separation was done using Sala HGMS 10-15-20 device. The unpurified FGD gypsum was fed to the magnetic separator as an aqueous slurry having a dry matter content of 25 wt-%. The feed steam contained 7 kg dry gypsum and thus 28 kg of wet gypsum. The feed time in each experiment was 150 s, the intermediate rinsing time was 30 s, and the exhaust time was 1 s. The matrix used in the magnetic separator was of the size suitable for 0.35 mm particles. The density of the magnetic flux was 1.5 T.

The slurry was fed trough the magnetic separator. The magnetic particles were removed from the slurry into the matrix of the magnetic separator. The slurry exhausted from the separator was recovered and thereafter filtrated so that water was separated from the gypsum. The properties of the obtained gypsum were measured.

In the tests where gypsum was purified according to the invention with both magnetic separation and acid wash, the partly purified gypsum obtained from the above described magnetic separation was used as raw material for the acid wash.

The purification test results are shown in Table 1. Raw FGD Gypsum, which was used as the starting material had a brightness (measured according to R457 +UV) of 90.4, a yellowness (measured according to DIN6167) of 3.4 and whiteness (measured according to L* D65) of 97.1. The comparison test M1 (Wet magnet alone) shows that magnetic separation alone improves the brightness, yellowness and whiteness. The comparison tests A1 to A5 (Acid wash alone) show that also acid wash alone improves the brightness, yellowness and whiteness.

The results from the inventive method using both magnetic separation and acid wash show clear improvement of brightness, yellowness and whiteness compared to the comparison tests. Further the results show that especially the yellowness could be improved by using several successive magnetic separation steps.

TABLE 1
Purification test results

| Purification process | Temperature | | Time | Brightness | Yellowness | Whiteness |
|---|---|---|---|---|---|---|
| (sample no.) | [° C.] | pH | [min] | R457 (+UV) | DIN6167 | L*D65 |
| Raw FGD Gypsum (start material) | — | — | — | 90.4 | 3.4 | 97.1 |
| Wet magnet alone (comparison test) | | | | | | |
| Magnet (M1) | — | — | — | 93.3 | 2.6 | 98.1 |
| Acid wash alone (comparison tests) | | | | | | |
| Acid wash (A1) | 70 | 2.5 | 60 | 94.3 | 1.2 | 98.1 |
| Acid wash (A2) | 70 | 2.5 | 10 | 93.9 | 1.3 | 97.9 |
| Acid wash (A3) | 60 | 2.5 | 120 | 94.2 | 1.2 | 98.0 |
| Acid wash (A4) | 50 | 2.5 | 120 | 93.8 | 1.2 | 97.9 |
| Acid wash (A5) | 40 | 2.4 | 120 | 93.5 | 1.4 | 97.8 |
| Magnetic separation + Acid wash | | | | | | |
| Magnet + acid wash (MA1) | 70 | 2.4 | 60 | 95.3 | 1.1 | 98.4 |
| Magnet + acid wash (MA2) | 60 | 2.3 | 60 | 95.4 | 1.1 | 98.5 |
| Magnet + acid wash (MA3) | 50 | 2.3 | 60 | 95.3 | 1.1 | 98.5 |
| Magnet + acid wash (MA4) | 50 | 1.8 | 60 | 95.5 | 1.0 | 98.5 |
| Magnet + acid wash (MA5) | 35 | 1.8 | 60 | 95.4 | 1.1 | 98.5 |
| Magnet + acid wash (MA6) | 22 | 1.8 | 60 | 94.8 | 1.4 | 98.3 |
| 2× Magnet + Acid wash (MA7) | 22 | 1.8 | 10 | 94.8 | 1.3 | 98.3 |
| 2× Magnet + Acid wash (MA8) | 22 | 1.8 | 30 | 95.3 | 0.9 | 98.4 |
| 2× Magnet + Acid wash (MA9) | 22 | 1.8 | 50 | 95.4 | 1.0 | 98.5 |
| 2× Magnet + Acid wash (MA10) | 22 | 1.8 | 70 | 95.4 | 1.0 | 98.5 |
| 2× Magnet + Acid wash (MA11) | 22 | 1.8 | 90 | 95.4 | 1.1 | 98.5 |

1-22. (canceled)

23. A method of purifying flue gas desulfurization (FGD) gypsum, comprising the steps of:
providing an aqueous slurry containing said FGD gypsum;
passing said aqueous slurry to a magnetic separator; and
contacting the FGD gypsum to be purified with a solution containing an acid and having pH below 5 in an acid washing step.

24. The method according to claim 23, wherein the magnetic separator used in step b) is a high gradient magnetic separation (HGMS) unit or a magnetic separation unit using superconductive magnet.

25. The method according to claim 23, wherein the magnetic separator is operated with a magnetic flux density above 0.1 Tesla.

26. The method according to claim 23, wherein the aqueous slurry containing the FGD gypsum formed in step a) has a solids content from 5 wt-% to 80 wt-% based on the total mass of the slurry.

27. The method according to claim 23, wherein in step c) the pH of the acid containing solution is below 4.

28. The method according to claim 23, wherein step c) is performed at a temperature above 10° C.

29. The method according to claim 23, wherein the step c) is performed in a mixing vessel.

30. The method according to claim 29, wherein the FGD gypsum has a residence time in said mixing vessel of more than 1 minute.

31. The method according to claim 30, wherein the residence time of the FGD gypsum in said mixing vessel is from 0.5 hours to 2.0 hours.

32. The method according to claim 23, wherein metallic impurities contained in the aqueous slurry that are removed during step b) include at least one metal selected from the group consisting of Fe, Sr, Mg, Al, Si, Cu, Zn, Pb, Cr, Co, La, Ce, Nd and Y.

33. The method according to claim 23, further comprising screening the aqueous slurry.

34. The method according to claim 33, wherein the screening is done in the magnetic separator, the magnetic separator comprises a magnetic mesh, and the magnetic mesh works also as a screening unit.

35. The method according to claim 33, wherein the FGD gypsum and water are fed to a mixer to provide the aqueous slurry containing said FGD gypsum, the aqueous slurry is then passed to the magnetic separator and magnetic components contained in said aqueous slurry are removed, after removal of the magnetic components the aqueous slurry is transferred for the acid washing step to a vessel, wherein also the acid is fed, the slurry is kept under the acidic conditions for a period of time whereafter purified FGD gypsum is separated from the slurry and rinsed with water, finally the rinsed product is recovered as purified FGD gypsum.

36. The method according to claim 35, wherein the rinsing water also contains an alkali to control the pH of the product.

37. The method according to claim 36, wherein the alkali comprises calcium hydroxide, sodium hydroxide, potassium hydroxide, or ammonia.

38. The method according to claim 35, wherein waste water from slurry and rinsing water is collected into a clarifier after the purified FGD gypsum is separated therefrom and overflow water from the clarifier is circulated back to first stage where water and unpurified FGD gypsum are mixed.

39. The method according to claim 35, wherein the alkali is added to the rinsing water in an amount which is adequate raise the pH of the product to at least 5.

40. The method according to claim 35, wherein the acid washing step is prior to the magnetic separation.

41. The method according to claim 35, wherein the acid is added to the mixer together with the FGD gypsum and water in order top form an acidic FGD gypsum slurry.

42. A purified FGD gypsum obtained by the method according to claim 23.

43. A product comprising the purified FGD gypsum as a coating or filler pigment according to claim 42, wherein said product is a paper or a board.

44. A building material comprising the purified FGD gypsum according to claim 42.
